(19) United States
(12) Patent Application Publication
(10) Pub. No.: US 2026/0063785 A1
(43) Pub. Date: Mar. 5, 2026

(54) TARGET TRACKING APPARATUS, TARGET TRACKING METHOD, AND TARGET TRACKING PROGRAM

(71) Applicant: Furuno Electric Co., Ltd., Nishinomiya (JP)

(72) Inventors: Seiichi UOSHITA, Nishinomiya (JP); Daisuke FUJIOKA, Takarazuka (JP)

(21) Appl. No.: 19/234,671

(22) Filed: Jun. 11, 2025

(30) Foreign Application Priority Data
Sep. 3, 2024 (JP) 2024-151101

(51) Int. Cl. G01S 13/72; G01S 7/04; G01S 7/41; G01S 13/42; G01S 13/58

(52) U.S. Cl. CPC G01S 13/726; G01S 7/04; G01S 7/41; G01S 13/42; G01S 13/589

(57) ABSTRACT

A target tracking apparatus for tracking a target, includes: an echo data input terminal configured to acquire echo data indicating the correspondence between the position in the detecting area and the level of reflected waves; a processing circuitry configured to: detect one or a plurality of potential tracking targets having a level of the reflected wave equal to or higher than a predetermined value based on the echo data; estimate the predicted position of the potential tracking targets in the future; set an area where the potential tracking targets to be tracked may exist, including the predicted position; select a tracking target from one or a plurality of the potential tracking targets in the area; track the selected tracking target as a tracking target. The processing circuitry may further be configured to: calculate an index value indicating fluctuation of the target; and set the area based on the index value.

### CROSS REFERENCE TO RELATED APPLICATIONS

The application claims priority under 35 U.S.C. § 119 to Japanese Patent Application No. JP 2024-151101, which was filed on Sep. 3, 2024, the entire disclosure of which is hereby incorporated by reference.

### TECHNICAL FIELD

The present disclosure mainly relates to a target tracking apparatus and more specifically to tracking of targets detected by radar or other detection sensors mounted on water vessels.

### BACKGROUND

Conventionally, a technique for suppressing clutter has been developed in a radar equipment having a function of tracking a target based on echo data.

However, in addition to the technology, a technology capable of tracking a target more accurately is desired.

The purpose of this disclosure is to provide a target tracking apparatus, a target tracking method, and a target tracking program capable of tracking a target more accurately.

### SUMMARY

A target tracking apparatus according to the present disclosure is a target tracking apparatus for performing tracking processing for tracking a target in a detection target area, wherein the apparatus comprises an echo data input terminal configured to acquire echo data indicating the correspondence between the position in the detecting area and the level of reflected waves; a processing circuitry configured to: detect one or a plurality of potential tracking targets as one or plurality of potential tracking targets to be selected (target candidates), having a level of the reflected wave equal to or higher than a predetermined value based on the echo data; estimate the predicted position of the potential tracking targets in the future; set an area where the potential tracking targets to be tracked may exist, including the predicted position; select a tracking target from one or a plurality of the potential tracking targets in the area; track the selected tracking target as a tracking target.

In the target tracking apparatus, the processing circuitry may further be configured to: repeatedly set the area based on the previous position of the selected tracking target. Here, in the target tracking apparatus, the processing circuitry may be configured to set the area based on the predicted position at a latest timing, in the case that the tracking target is missing. Also, the processing circuitry may be configured to set the area based on the predicted position at a latest timing, in the case that the tracking target is not determined.

Compared with the configuration in which the target to be tracked is selected from among all the reflectors in the detection target area, the target may be selected as the tracking target by a simple process while suppressing mis-tracking due to selecting the clutter generation position as the tracking target. Therefore, the target may be more accurately tracked.

In the above target tracking apparatus, the processing circuitry may further be configured to calculate an index value indicating fluctuation (wobble) of the target; and set the area based on the index value. By adopting such a configuration, for example, the apparatus makes it possible to set an area corresponding to the magnitude of the fluctuation of the target, and therefore, makes it possible to set an area in which the target is more reliably included while narrowing the reflector of the potential tracking target. In the target tracking apparatus, the processing circuitry may select the tracking target having the minimum index value in the area.

Here, by transmitting and receiving electromagnetic waves at predetermined time intervals, physical data such as the position and speed of the target is repeatedly acquired. When the target is tracked based on these physical data obtained at each timing, changes occur in the position and speed of the target detected by the radar. For example, when the transmission and reception interval of electromagnetic waves is constant and the speed of the target does not change, the speed of the detected target should be constant, and the position should change in the moving direction of the target at regular intervals.

However, in practice, detection errors may occur, and the target may change its speed or direction. As a result, the position of the detected target may be different from the position estimated from the speed and the movement until then, and it may be detected as if a fluctuation occurs. Here, these are called Fluctuations, and the numerical value indicating the degree corresponding to each physical data is called the index value IN.

In the target tracking apparatus, wherein the processing circuitry may further be configured to: calculate an index value based on the change in the velocity vector of the target; and set the area based on the index value. By adopting such a configuration, for example, since the area corresponding to the amount of change in the velocity vector of the target may be set, the area in which the target is more reliably included may be set while the reflector of the potential tracking target is narrowed.

In the target tracking apparatus, the processing circuitry may further be configured to: calculate an index value based on the change in the velocity vector of the target; and set the area based on the index value. By adopting such a configuration, for example, since the area corresponding to the amount of change in the speed of the target may be set, the area in which the target is more reliably included may be set while narrowing the reflector of the potential tracking target.

In the target tracking apparatus, the processing circuitry may further be configured to: calculate an index value based on change in the position of the target; and set the area based on the index value. By adopting such a configuration, for example, since the area corresponding to the amount of change in the position of the target may be set, the area in which the target is more surely included may be set while narrowing the reflector of the potential tracking target.

In the target tracking apparatus, the processing circuitry may further be configured to: calculate an index value based on the velocity of the target; and set the area based on the index value. By adopting such a configuration, for example, since it is possible to set an area having a size corresponding to the speed of the target, it is possible to set an area in which the target is more surely included while narrowing the reflector of the potential tracking target.

In the target tracking apparatus, the processing circuitry may further be configured to: calculate an index value based on the size of the target; and set the area based on the index value. By adopting such a configuration, for example, since the observation position of the target has a fluctuation corresponding to the size of the target, the area may be set in consideration of, for example, the fluctuation which may occur according to the size of the target, and the area in which the target is more reliably included may be set while narrowing the reflector of the potential tracking target.

When the tracking target cannot be selected because the echo signal of the target cannot be detected, the next area may be set by interpolating the observation position of the target using the predicted position of the target. Therefore, erroneous tracking due to the setting of the next region based on the clutter occurrence position may be suppressed.

In the target tracking apparatus, the processing circuitry may further be configured to: calculate an index value indicating fluctuation of the target; and select the tracking target based on the index value.

The target tracking apparatus may further comprises: an antenna; a transmitter/receiver configured to transmit an electromagnetic wave through an antenna and receive a reflected signal from which the transmitted electromagnetic wave is reflected by a reflector; a target detector configured to: receive a reflected signal wave reflected in the detecting area by electromagnetic waves transmitted through an antenna, generate the echo database on the reflected signal, and output the echo data into the processing circuitry; and a display configured to display the tracked target.

A target tracking method for tracking a target according to the present disclosure, comprising: receiving a reflected signal wave reflected in the detecting area by electromagnetic waves transmitted through an antenna; outputting echo data indicating the correspondence between the position in the detecting area and the level of reflected waves; detecting one or a plurality of potential tracking targets having a level of the reflected wave equal to or higher than a predetermined value based on the echo data; estimating the predicted position of the potential tracking targets in the future; setting an area where the potential tracking targets to be tracked may exist, including the predicted position; selecting a tracking target from one or a plurality of the potential tracking targets in the area; tracking the selected tracking target as a tracking target.

The target tracking method may further comprise calculating an index value indicating fluctuation of the target, and setting the area based on the index value.

A non-transitory computer readable medium having stored thereon computer-executable instructions which, when executed by a computer, cause the computer to: receive a reflected signal wave reflected in the detecting area by electromagnetic waves transmitted through an antenna; output echo data indicating the correspondence between the position in the detecting area and the level of reflected waves; detect one or a plurality of potential tracking targets having a level of the reflected wave equal to or higher than a predetermined value based on the echo data; estimate the predicted position of the potential tracking targets in the future; set an area where the potential tracking targets to be tracked may exist, including the predicted position; select a tracking target from one or a plurality of the potential tracking targets in the area; track the selected tracking target as a tracking target.

### BRIEF DESCRIPTION OF DRAWINGS

FIG. 1 is a diagram showing the configuration of a radar equipment according to an embodiment of the present disclosure;

FIG. 2 is a diagram showing the configuration of an echo data processor according to an embodiment of the present disclosure;

FIG. 3 is a diagram showing an example of an echo image displayed by a processing unit of a radar equipment according to an embodiment of the present disclosure;

FIG. 4 is a diagram showing an example of tracking processing in a processing unit of a radar equipment according to an embodiment of the present disclosure;

FIG. 5 is a diagram showing an example of tracking processing in a processing unit of a radar equipment according to an embodiment of the present disclosure;

FIG. 6 is a diagram showing an example of tracking processing in a processing unit of a radar equipment according to an embodiment of the present disclosure;

FIG. 7 is a diagram showing an example of tracking processing in a processing unit of a radar equipment according to an embodiment of the present disclosure;

FIG. 8 is a diagram showing an example of a method of calculating an index value by a processing unit of a radar equipment according to an embodiment of the present disclosure;

FIG. 9 is a diagram showing an example of a method of calculating an index value by a processing unit of a radar equipment according to an embodiment of the present disclosure;

FIG. 10 is a diagram showing an example of an area set by a processing unit of a radar equipment according to an embodiment of the present disclosure;

FIG. 11 is a diagram showing another example of an area set by a processing unit of a radar equipment according to an embodiment of the present disclosure;

FIG. 12 is a diagram showing another configuration of an echo data processor according to an embodiment of the present disclosure;

FIG. 13 is a flowchart showing an example of an operation when a target tracking apparatus of a radar equipment according to an embodiment of the present disclosure generates concatenated echo data;

FIG. 14 is a flowchart showing an example of an operation when a target tracking apparatus of a radar equipment according to an embodiment of the present disclosure performs tracking processing and

FIG. 15 is a flowchart showing another example of an operation when a target tracking apparatus of a radar equipment according to an embodiment of the present disclosure performs tracking processing.

### DETAILED DESCRIPTION

Embodiments of the present disclosure will be described below with reference to the drawings. The same reference numerals are assigned to the same or equivalent parts in the drawings, and the description thereof will not be repeated. In addition, at least a part of the following embodiments may be optionally combined.

### Configuration and Basic Operation

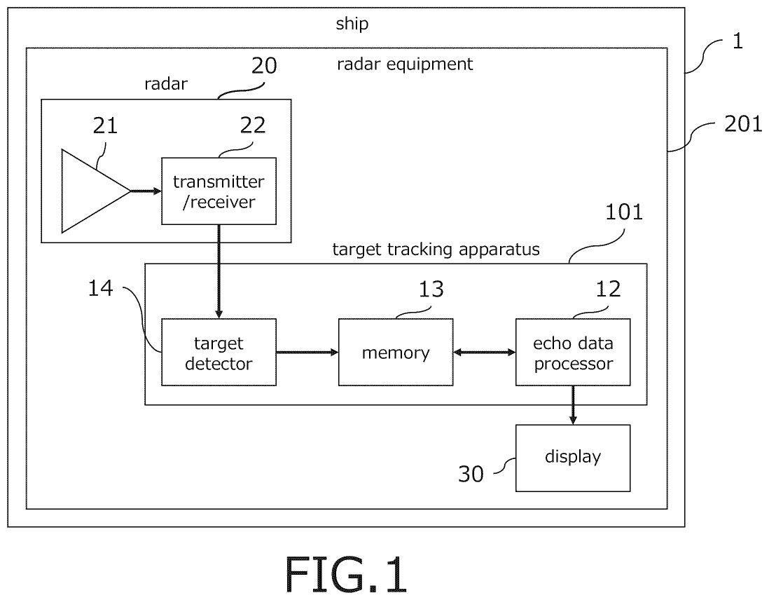

FIG. 1 is a diagram showing the configuration of a radar equipment according to an embodiment of the present disclosure.

Referring to FIG. 1, the radar equipment 201 comprises a radar 20, a display 30, and a target tracking apparatus 101. The target tracking device can be exemplified by the target tracking apparatus 101. The radar 20 comprises an antenna 21 and a transmitter/receiver 22. The target tracking apparatus 101 comprises a target detector 14, an echo data processor 12, and a memory 13.

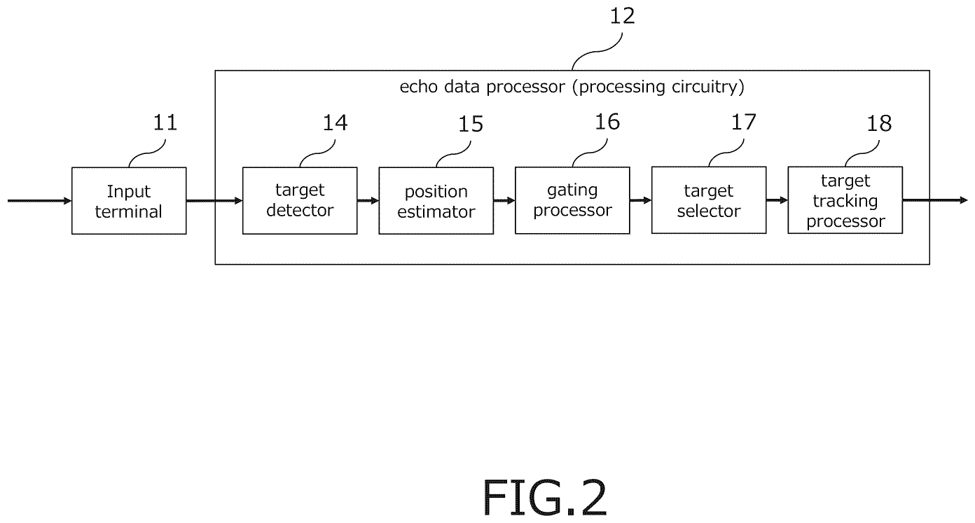

FIG. 2 is a diagram showing the configuration of an echo data processor 12 according to an embodiment of the present disclosure. The echo data processor 12 comprises a target detector 14, a position estimator 15, a gating processor 16, a target selector 17 and a target tracking processor 18. The processing circuitry implements all or part of the transmitter/receiver 22, the input terminal 11, and the echo data processor 12. The processing circuit comprises a non-volatile memory, which serves as the storage unit 13.

The radar equipment 201 is mounted on ship 1. The target tracking apparatus 101 performs tracking processing to track a target S of other vessels in a detection target area Ta. The target tracking apparatus 101 performs processing to display an echo image showing the position of the target S tracked in the tracking processing on the display 30. For example, the detection target area Ta is an area inside a circle of a predetermined size that has ship 1 at its center. The radar 20 generally emits electromagnetic waves to its surroundings from the antenna 21 rotating at a constant angular velocity, so the detected echo data are inputted into the input terminal 11 at a constant period.

### Radar Equipment

The radar 20 generates divided echo data EdD, which is echo data Ed showing the correspondence between the position in the divided target area Da and the echo level at the position based on the reflected wave from the electromagnetic waves that the antenna 21 transmits. The divided target area Da is a fan-shaped area in which the detection target area Ta is divided into N pieces along an azimuthal direction. The number of N is an integer of 2 or more. The echo level at each position of the divided echo data EdD indicates the level of the reflected wave reflected at the position. For example, the radar 20 generates divided echo data EdD at generation timing Gd following a predetermined generation cycle Cd.

More specifically, the transmitter/receiver 22 transmits electromagnetic waves through the antenna 21 during a sweep period T of a predetermined length and receives reflected waves from the transmitted electromagnetic waves through the antenna 21. The transmitter/receiver 22 digitally converts the echo signal, indicating the received reflected waves to generate digital data Dd. The transmitter/receiver 22 repeats transmission of electromagnetic waves and generation of digital data Dd while rotating the antenna 21 in order to the azimuth angle in the transmission direction of electromagnetic waves changes by a predetermined angle for each sweep period T. Each time the transmitter/receiver 22 generates digital data Dd, it outputs the generated digital data Dd to the target detector 14 through the input terminal 11 located between the transmitter/receiver 22 and the target detector 14.

The target detector 14 generates divided echo data EdD based on a plurality of digital data Dd received from the transmitter/receiver 22. For example, the target detector 14 generates divided echo data EdD in which echo levels at a plurality of positions in the area Da to be divided are binarized. More specifically, among the plurality of positions in the area Da to be divided, the echo level value at a position where the echo level is equal to or greater than a predetermined threshold is converted to “1” and the echo level value at a position where the echo level is less than the threshold is converted to “0” to generate divided echo data EdD. Each time the target detector 14 generates divided echo data EdD, it transmits the generated divided echo data EdD to the target tracking apparatus 101.

### Target Tracking Apparatus:

The target detector 14 in the target tracking apparatus 101 acquires a concatenated echo data EdC which corresponds to echo data Ed, indicating the correspondence between the position in the detection target area Ta and the echo level at the position. For example, the target detector 14 acquires concatenated echo data EdC at the generation timing Gs following the scan period Cs, which is N times the generation period Cd. More specifically, the target detector 14 receives the divided echo data EdD from the transmitter/receiver 22 and stores the divided echo data EdD that it receives in the memory 13.

The target detector 14 acquires N pieces of divided echo data EdD from the memory 13 and connects them each time N pieces of divided echo data EdD that it accumulates in the memory 13 reach N pieces, thereby generating a connected echo data EdC. The target detector 14 stores the connected echo data EdC that it generates in the memory 13.

The echo data processor 12 performs tracking processing to track the target S based on the echo data Ed. More specifically, the echo data processor 12 specifies coordinates indicating the current position of the target S based on the concatenated echo data EdC every time the concatenated echo data EdC is stored in the memory 13 by the target detector 14. Then, the echo data processor 12 calculates the velocity vector Vc of the target S based on the coordinates of the target S specified based on the concatenated echo data EdC, the coordinates of the target S specified based on the concatenated echo data EdC at the past generation timing Gs, and the scan period Cs.

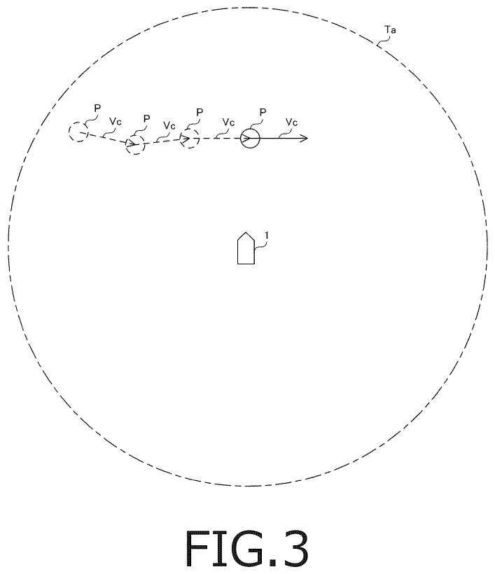

FIG. 3 is a diagram showing an example of an echo image displayed by the target detector 14 in the radar 20 according to the embodiment of the present disclosure. In FIG. 3, a solid circle indicates the latest observation position P of target S, and a dashed circle indicates the past observation position P of target S. In FIG. 3, a solid arrow indicates the latest velocity vector Vc of target S, and a dashed arrow indicates the past velocity vector Vc of target S.

Referring to FIG. 3, the echo data processor 12 performs a process of displaying the tracking result of the target S. More specifically, the echo data processor 12 generates an echo image including the observed position P of the target S in the detection target area Ta and the velocity vector Vc of the target S and performs a process of displaying the echo image that it generates on the display 30. The echo data processor 12 updates the echo image it displays on display 30 each time the target detector 14 stores the connected echo data EdC in the memory 13.

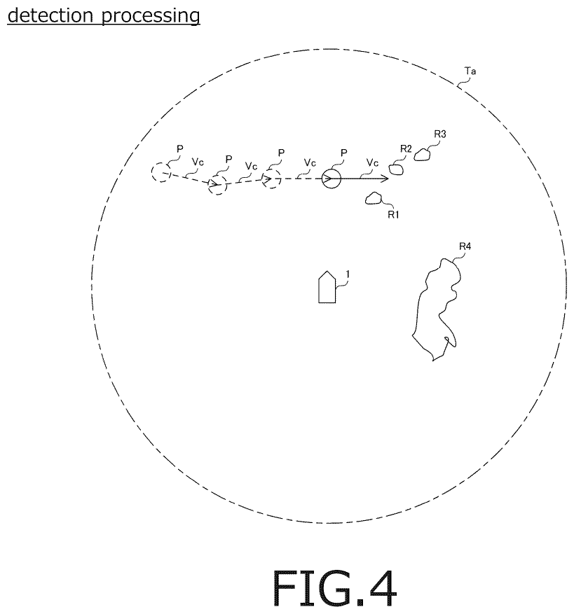

FIGS. 4 to 7 show an example of tracking processing in the radar equipment 201 by the target tracking apparatus 12 according to the embodiment of the present disclosure. FIGS. 4 to 7 show (1) detection processing, (2) gating processing, (3) selection processing, and (4) update processing, respectively.

Referring to FIGS. 4 to 7, in the tracking processing, the echo data processor 12 performs detection processing to detect the reflector R, gating processing to set the area Ar where the target S to be tracked may exist, selection processing to select the tracking target Tt, and update processing to update the echo image based on the selection result of the tracking target Tt.

Detection process-Referring to FIG. 4, in the detection process, the echo data processor 12 detects a plurality of reflectors R, which are reflectors whose level of reflected wave is greater than or equal to a predetermined value, based on the concatenated echo data EdC. For example, in the detection target area Ta, the echo data processor 12 detects reflectors R1, R2, R3, and R4, which are reflectors R, as potential tracking targets that the processor may select as the next target in the tracking process. The reflector R4 is land. In the detection process, the echo data processor 12 may detect a reflector R whose area is less than a predetermined value as a potential tracking target, while excluding a reflector R, such as land whose area is greater than or equal to a predetermined value from the potential tracking target.

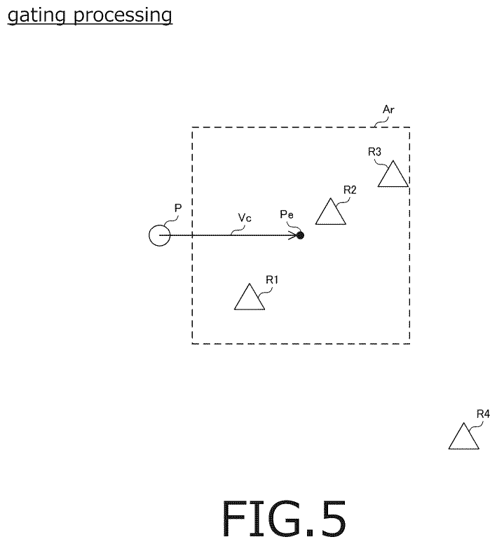

Gating process-Referring to FIG. 5, in the gating process, the echo data processor 12 sets an area Ar that comprises a predicted position Pe of the target S and may contain the target S to be tracked. More specifically, the position estimator 15 of the echo data processor 12 estimates the predicted position Pe of the target S at the next generation timing Gs of the concatenated echo data EdC based on the latest observation position P of the target S and the latest velocity vector Vc.

Then, the gating processor 16 sets a quadrilateral area Ar centered on the estimated predicted position Pe. The shape of the area Ar is not limited to a quadrilateral, but may be a polygon other than a quadrilateral, a circle, an ellipse, or a fan. In FIG. 5, all reflectors R are represented by triangles of the same size for the purpose of explanation.

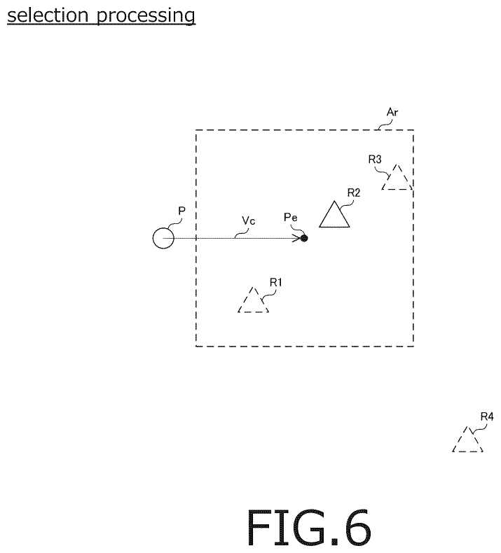

Selection Process-Referring to FIG. 6, in the selection process, the target selector 17 selects a tracking target Tt from one or more reflectors R in the area Ar. For example, the target selector 17 selects a reflector R2 out of reflectors R1, R2, and R3 in the area Ar as a tracking target Tt. In FIG. 5, the reflectors R1, R3, and R4 not selected as the tracking target Tt are indicated by dashed triangles.

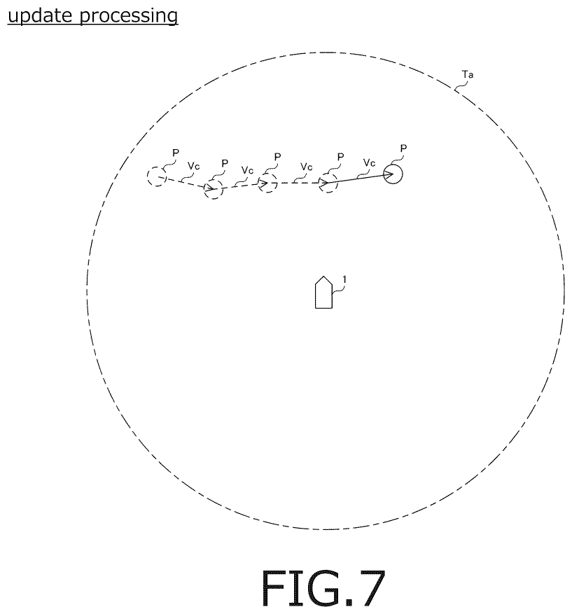

Update process-Referring to FIG. 7, the target tracking processor 18 performs tracking processing for tracking the tracking target Tt as the target S. More specifically, in the update processing, the echo data processor 12 generates an echo image including the latest observation position P and the latest velocity vector Vc and updates the echo image it displays on the display 30 to the generated echo image. The echo data processor 12 repeats the detection processing, the gating processing, the selection processing, and the update processing in this order. Note that the order of the gating processing and the detection processing is not limited to the above, and the order may be changed.

### Details of Gating and Selection Processing:

Referring again to FIG. 7, for example, the echo data processor 12 sets the area Ar based on the index value IN indicating the fluctuation of the target S, the speed of the target S, and the size of the target S. The index value IN is a statistical value calculated based on the amount of change in the speed vector Vc of the target S. Specific examples of gating and selection processing will be described below.

### Embodiment 1

In the gating process, the gating processor 16 excludes the reflector R4 outside the region Ar from the potential tracking target among the reflectors R1, R2, R3, and R4. Next, the gating processor 16 calculated an index value IN indicating the fluctuation of the target S when each reflector R is selected as the tracking target Tt for the reflectors R1, R2 and R3 other than the reflector R4 that has already been excluded from the potential tracking target in the selection process. The target selector 17 selects the tracking target Tt based on the calculated index value IN.

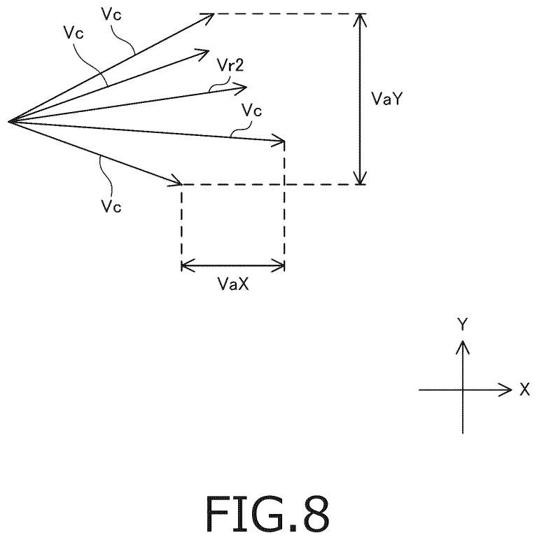

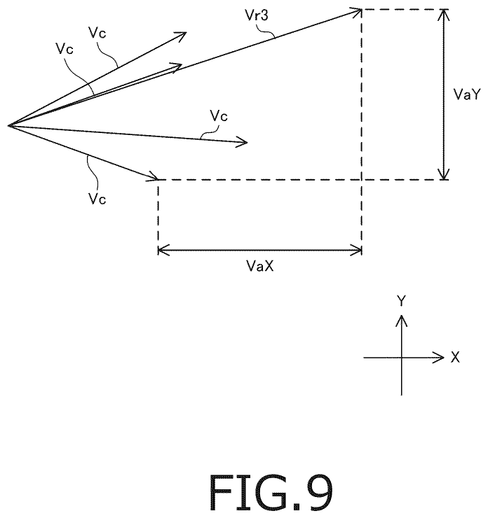

FIGS. 8 and 9 show an example of the method of calculating the index value by the gating processor 16 of the echo processor 12 in the tracking target apparatus 101 according to the embodiment of the present disclosure. In FIGS. 8 and 9, the X direction is the east-west direction, and the Y direction is the north-south direction.

Referring to FIG. 8, the gating processor 16, as shown in FIG. 2, calculates the velocity vector Vr2, which is the velocity vector Vc of the target S when the reflector R2 is selected as the tracking target Tt, that is, the target S.

Then, the gating processor 16 calculates the absolute value Va of the difference between the maximum value and the minimum value of the nearest five velocity vectors Vc, including the velocity vector Vr2 as the index value IN when the reflector R2 is selected as the tracking target Tt. More specifically, the gating processor 16 calculates the absolute value VaX of the difference between the maximum value and the minimum value of the five velocity vectors Vc in the X direction and the absolute value VaY of the difference between the maximum value and the minimum value of the five velocity vectors Vc in the Y direction as the absolute value Va.

Referring to FIG. 9, the gating processor 16 calculates the velocity vector Vr3, which is the velocity vector Vc of the target S when the reflector R3 is selected as the tracking target Tt, that is, the target S. Then, the gating processor 16 calculates the absolute value Va of the difference between the maximum value and the minimum value of the nearest five velocity vectors Vc, including the velocity vector Vr3, as the index value IN when the reflector R3 is selected as the tracking target Tt. More specifically, the gating processor 16 calculates, as the absolute value Va, the absolute value VaX of the difference between the maximum value and the minimum value of the five velocity vectors Vc in the X direction, and the absolute value VaY of the difference between the maximum value and the minimum value of the five velocity vectors Vc in the Y direction.

Similarly, the gating processor 16 calculates absolute values VaX and VaY when the reflector R1 is selected as the tracking target Tt. The echo data processor 12 may be configured to calculate absolute values VaX and VaY using 2, 3, 4, or 6 or more velocity vectors Vc.

Next, the target selector 17 compares the calculated absolute values VaX and VaY with the threshold Th1. For example, the threshold Th1 is set to a value based on the size of the target S. When the absolute values VaX and/or VaY when the reflector R is selected as the tracking target Tt is larger than the threshold Th1, the target selector 17 excludes the reflector R from a potential tracking target (a tracking candidate).

For example, when both absolute values, VaX or VaY for the selected reflector R are smaller than the threshold Th1, the target selector 17 of the echo data processor 12 does not exclude the reflector R from the potential tracking target. On the other side, when either of the absolute values VaX or VaY is larger than the threshold Th1, the target selector excludes the reflector R from the potential tracking target. Here, in comparison with the respective thresholds of the absolute values VaX and VaY, the thresholds for VaX and VaY may be the same, but not necessarily the same, and may be different.

After that, the target selector 17 may select the tracking target having the minimum index value in the area.

As an example, the target selector 17 excludes the reflector R3 from the potential tracking target because the absolute values VaX and VaY when the reflector R3 is selected as the tracking target Tt are larger than the threshold Th1. On the other hand, the target selector 17 maintains the reflector R1 as the potential tracking target because the absolute values VaX and VaY when the reflector R1 is selected as the tracking target Tt are smaller than the threshold Th1. The target selector 17 maintains the reflector R2 as the potential tracking target because the absolute values VaX and VaY when the reflector R2 is selected as the tracking target Tt are smaller than the threshold Th1.

Referring again to FIG. 6, the target selector 17, as shown in FIG. 2, selects the tracking target Tt based on the distance Ds between the reflector R of the potential tracking target and the predicted position Pe. More specifically, the target selector 17 selects the reflector R2 having the smallest distance to the predicted position Pe as the tracking target Tt among the reflectors R1 and R2, which are the remaining potential tracking targets.

Instead of selecting the tracking target Tt based on the distance Ds, the target selector 17 may select the tracking target Tt based on the absolute values VaX and VaY, which are the index values IN of the fluctuation. In this case, the target selector 17 selects as the tracking target Tt the reflector R2, which has the smallest absolute values VaX and VaY when selected as the tracking target Tt among the reflectors R1 and R2, which are the remaining potential tracking targets.

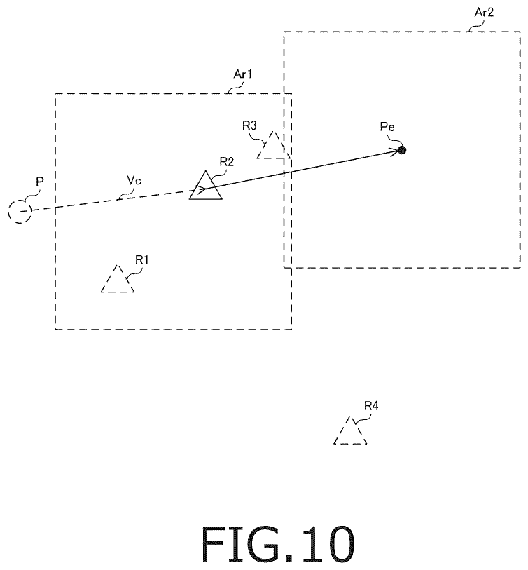

FIG. 10 shows an example of an area set by the gating processor 16 of the echo data processor 12 in the radar equipment 201, according to the embodiment of the present disclosure. FIG. 10 shows areas Ar1 and Ar2, which are areas Ar. Referring to FIG. 10, the gating processor 16 sets the area Ar each time detection data of the target is inputted. For example, when the target selector 17 selects the tracking target Tt in area Ar1, it sets the next area Ar2 based on the position of the reflector R selected as the tracking target Tt.

More specifically, the echo data processor 12 determines that the reflector R2 is the target S and calculates the velocity vector Vc of the target S. The position estimator 15 estimates the predicted position Pe of the target S at the next generation timing Gs of the concatenated echo data EdC based on the observed position P of the target S and the calculated velocity vector Vc. The observed position P may be the position of the reflector R2 or a position obtained by performing predetermined arithmetic processing for smoothing the observed position P with respect to the position of the reflector R2.

The gating processor 16 sets the area Sar of the area Ar based on the size of the target S, the speed of the target S, and the index value IN of the fluctuation. For example, the gating processor 16 sets the area Ar of the larger area Sar as the size of the target S increases, the area Ar of the larger area Sar as the speed of the target S increases, and the area Ar of the larger area Sar as the index value IN increases. As an example, the gating processor 16 substitutes parameters such as the size of the target S, the speed of the target S, and the index value IN into a predetermined calculation formula to obtain the area Sar corresponding to the parameters.

The gating processor 16 sets the area Ar2 with the estimated predicted position Pe as the center and the set area Sar. The gating processor 16 may set the area Sar without using the size of the target S, the speed of the target S, or a part of the index value IN. The area Sar may be a preset fixed value.

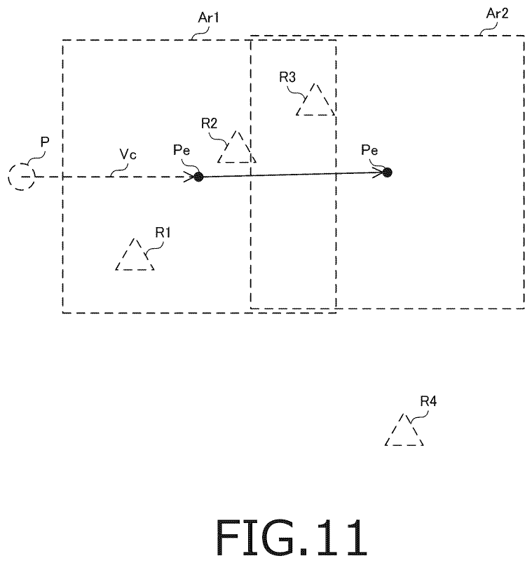

FIG. 11 is a diagram showing another example of the area set by the gating processor 16 in the radar equipment 201 according to the embodiment of the present disclosure. FIG. 11 shows areas Ar1 and Ar2, which are areas Ar. Referring to FIG. 11, when no tracking target Tt is selected in area Ar1, the gating processor 16 sets the next area Ar2 based on the predicted position Pe in area Ar1.

More specifically, the reflector R1 is selected as the potential tracking target, but either of the absolute values VaX or VaY for the selected reflector R1 is larger than the threshold Th1, the target selector 17 excludes the reflector R1 from the potential tracking targets. In a similar manner, even when the reflectors R2 and R3 are selected as the potential tracking target, but either of absolute values VaX or VaY for the selected reflectors R2 and R3 are larger than the threshold Th1, respectively, the target selector 17 excludes the reflector R2 and R3 from the potential tracking targets.

Based on the comparison result between the absolute values VaX and VaY and the threshold value Th1, the target tracking processor 18 of the echo data processor 12 performs an interpolation process to interpolate the tracking target by the predicted position Pe in area Ar1. This is because the tracking target becomes untraceable when all reflectors R in area Ar1 are excluded from the potential tracking target.

More specifically, the target tracking processor 18 assumes that the observed position P of target S is predicted position Pe, and calculates the velocity vector Vc of target S. The position estimator 15 calculates the predicted position Pe of target S at the next generation timing Gs of the concatenated echo data EdC based on the predicted position Pe in area Ar1 and the calculated velocity vector Vc. The target tracking processor 18 also sets the area Sar based on the size of target S, the speed of target S, and the index value IN of fluctuation.

The gating processor 16 sets the area Ar2, having the estimated predicted position Pe as the center and the set area Sar. The gating processor 16 may set the area Sar without using part of the size of target S, the speed of target S, and the index value IN. The area Sar may be a preset fixed value. When performing interpolation processing, the echo data processor 12 may be configured to accumulate the tracking result of target S in the background instead of updating the echo image showing the tracking result of target S. In addition, the echo data processor 12 may be configured to terminate the tracking processing without performing interpolation processing when the tracking becomes impossible.

### Embodiment 2

Referring again to FIG. 6, the target selector 17 excludes the reflector R4 from the reflectors R1, R2, R3, and R4 from the potential tracking target in the gating process as in Embodiment 1.

Next, in the selection process, the target selector 17 selects the tracking target Tt based on the distance Ds between the reflector R1, R2, R3, other than the reflector R4 excluded from the potential tracking target and the predicted position Pe. More specifically, the target selector 17 selects the reflector R2 having the smallest distance between the reflector R1, R2, and R3 and the predicted position Pe as the tracking target Tt.

Referring again to FIG. 8, the gating processor 16 calculates the velocity vector Vr2 of the target S when the reflector R2 is selected as the tracking target Tt, that is, the target S. Then, the gating processor 16 calculates absolute values VaX and VaY as the index values IN when the reflector R2 is selected as the tracking target Tt. The target selector 17 compares the calculated absolute values VaX and VaY with the threshold Th1.

Referring again to FIG. 10, the target detector 14 determines that the reflector R2 is the target S when both of the absolute values VaX and VaY of the reflector R2 are less than the threshold Th1, and then calculates the velocity vector Vc of the target S. Then, the gating processor 16 sets the area Ar2 in the same manner as in Embodiment 1.

Referring again to FIGS. 2 and 11, the target tracking processor 18 discards the selected tracking target Tt when the absolute values VaX and/or VaY, when the reflector R2 is selected as the tracking target Tt, is larger than the threshold Th1 and performs interpolation processing. More specifically, the gating processor 16 calculates the velocity vector Vc when the observation position P of the target S is assumed to be the predicted position Pe in the same manner as in Embodiment 1 and sets the area Ar2.

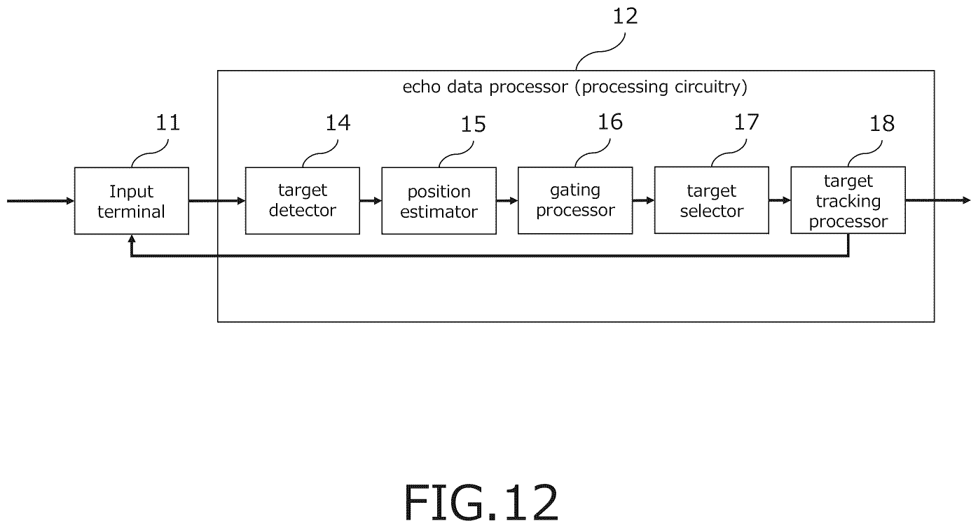

FIG. 12 shows the configuration of the echo data processor 18. Unlike the configuration shown in FIG. 2, in the configuration shown in FIG. 12, when the target tracking processor 18 cannot determine or misses the next target, it does not once set the selected tracking target Tt as the next target to be tracked but acquires the next detection data from the input terminal 11. The target tracking processor 18 outputs an instruction signal to the position estimator 15 in order to select a target from the next echo data acquired from the input terminal 11 and continues tracking by the same process.

Referring again to FIG. 6, the target selector 17 excludes the reflector R4 from the reflectors R1, R2, R3, and R4 from the potential tracking target in the gating process as in Embodiment 1.

Next, in the selection process, the target selector 17 of the echo data processor 12, as shown in FIG. 2, selects the tracking target Tt based on the distance Ds between the reflector R1, R2, R3 other than the reflector R4, excluded from the potential tracking target and the predicted position Pe. More specifically, the target selector 17 selects the reflector R2 having the smallest distance between the reflector R1, R2, and R3 and the predicted position Pe as the tracking target Tt.

Referring again to FIG. 8, the gating processor 16 calculates the velocity vector Vr2 of the target S when the reflector R2 is selected as the tracking target Tt, that is, the target S. Then, the gating processor 16 calculates absolute values VaX and VaY as the index values IN when the reflector R2 is selected as the tracking target Tt. The target selector 17 compares the calculated absolute values VaX and VaY with the threshold Th1.

Referring again to FIG. 10, the target selector 17 of the echo data processor 12 determines that the reflector R2 is the target S when both absolute values VaX and VaY of the detected reflector R2 are less than the threshold Th1, and calculates the velocity vector Vc of the target S. Then, the gating processor 16 sets the area Ar2 in the same manner as in Embodiment 1.

Referring again to FIG. 11, the target tracking processor 18 discards the selected tracking target Tt when either of the absolute values VaX or VaY of the detected reflector R2 is larger than the threshold Th1 and performs interpolation processing. More specifically, the gating processor 16 calculates the velocity vector Vc when the observation position P of the target S is assumed to be the predicted position Pe in the same manner as in Example 1 and sets the area Ar2.

### Another Example of Index Value in

The gating processor 16 may be configured to calculate absolute values VaX and VaY as the index value IN, but this is not limited. The gating processor 16 may be configured to calculate other statistical values based on the amount of change in the velocity vector Vc of the target S as the index value IN.

For example, the gating processor 16 extracts a plurality of X direction components Ix and a plurality of Y direction components Iy from a plurality of velocity vectors Vc, respectively.

The gating processor 16 may calculate the variance of a plurality of X direction components Ix, the standard deviation of a plurality of X direction components Ix, the average deviation of a plurality of X direction components Ix, the interquartile range (IQR) of a plurality of X direction components Ix, and the IQR of a plurality of X direction components Ix, instead of the absolute value VaX, as the index value IN.

The gating processor 16 may calculate the variance of a plurality of Y direction components Iy, the standard deviation of a plurality of Y direction components Iy, the average deviation of a plurality of Y direction components Iy, the IQR of a plurality of Y direction components Iy, and the IQR of a plurality of Y direction components Iy, instead of the absolute value VaY, as the index value IN.

The gating processor 16 may calculate the statistical value of the angle formed by a plurality of velocity vectors Vc, or the statistical value of the cosine distance of a plurality of velocity vectors Vc, instead of the absolute values VaX and VaY, as the index value IN. The gating processor 16 may calculate the combined value of the above plurality of statistical values as the index value IN.

The index value IN is a statistical value calculated based on the amount of change in the velocity vector Vc of target S, but is not limited thereto. The index value IN may be a statistical value calculated based on the amount of change in the velocity of target S. More specifically, the echo data processor 12 calculates a plurality of scalar velocities Sv corresponding to each of the plurality of velocity vectors Vc. The scalar velocity Sv is a scalar quantity of the velocity of target S. As the index value IN, the gating processor 16 may calculate the absolute value of the difference between the maximum value and the minimum value of the calculated scalar velocities Sv, the variance of the scalar velocities Sv, the standard deviation of the scalar velocities Sv, the average deviation of the scalar velocities Sv, the IQR of the scalar velocities Sv, and the IQR of the scalar velocities Sv.

The index value IN may be a statistical value calculated based on the position quantity of target S. More specifically, the gating processor 16 calculates the position change quantity Vp of the position of target S for each scan period Cs using the most recent observation positions P. The position change quantity Vp is a scalar quantity of the moving distance of target S. As the index value IN, the gating processor 16 may calculate the absolute value of the difference between the maximum value and the minimum value of the calculated position change quantities Vp, the variance of the position change quantities Vp, the standard deviation of the position change quantities Vp, the average deviation of the position change quantities Vp, the quartile range of the position change quantities Vp, and the interquartile deviation of the position change quantities Vp.

### Flow of Operation

A radar equipment 201 according to an embodiment of the present disclosure comprises a computer including a memory, and a processor, such as a CPU in the computer reads and executes a program including part or all of the steps of the following flowchart from the memory. The program of the apparatus may be installed externally. The program of the apparatus is distributed in a state stored in a recording medium or through a communication line.

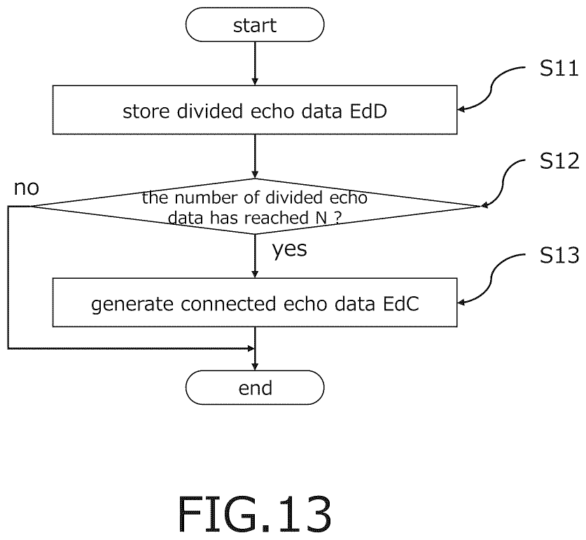

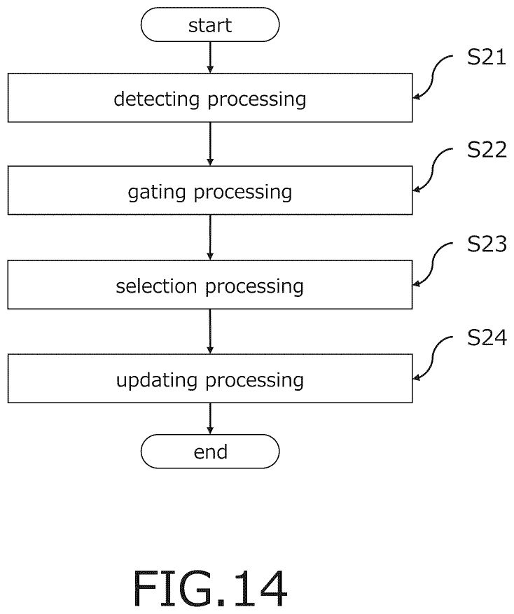

FIG. 13 is a flowchart showing an example of the operation when the target tracking apparatus 101 in the radar equipment 201 generates the concatenated echo data. Each time the input terminal 11 in the target tracking apparatus 101 receives the divided echo data EdD from the radar 20, it executes the process shown in FIG. 14.

Referring to FIG. 13, first, the target detector 14 of the target tracking processor 12 stores the divided echo data EdD received from the radar 20 in the memory 13 (step S11). Next, when the number of divided echo data EdD accumulated in the memory 13 does not reach N (NO in step S12), the target detector 14 terminates the processing.

On the other hand, when the number of divided echo data EdDs accumulated in the memory 13 reaches N (YES in step S12), the target detector 14 generates a connected echo data EdC by connecting the N divided echo data EdDs (step S12).

FIG. 14 is a flowchart showing an example of an operation when the target tracking apparatus 101 in the radar equipment 201 according to the embodiment of the present disclosure performs tracking processing. The echo data processor 12 in the target tracking apparatus 101 executes the processing shown in FIG. 13 each time a connected echo data EdC is generated by the gating processor 16.

Referring to FIGS. 1, 2, and 14, first, the target detector 14 in the target tracking apparatus 101 performs a detection process for detecting the reflector R in the detection target area Ta based on the concatenated echo data EdC generated by the target detector 14 (step 21).

After the position estimator 15 estimates each of a potential tracking target, the gating processor 16 performs a gating process to set the area Ar. More specifically, the gating processor 16 calculates the current predicted position Pe of the target S based on the past observation position P of the target S and the velocity vector Vc of the target S. The gating processor 16 sets the area Sar based on the size of the target S, the velocity of the target S, and the fluctuation index value IN. Then, the gating processor 16 sets the area Ar centered on the calculated predicted position Pe and having the set area Sar (step S22).

Next, the target selector 17 performs a selection process to select a tracking target Tt from one or more reflectors R in the area Ar. For example, the target selector 17 excludes from the potential tracking target the reflector R whose fluctuation index value IN is larger than a predetermined value when selected as the tracking target Tt among the reflectors R in the area Ar. Then, the target selector 17 selects the reflector R having the smallest distance from the predicted position Pe among the remaining reflectors R in the area Ar as the tracking target Tt (step S23).

Next, the target tracking processor 18 performs a tracking process to track the selected tracking target Tt as the target S. More specifically, the target tracking processor 18 generates an echo image including the observation position P of the target S and the velocity vector Vc of the target S and updates the echo image displayed on the display device 30 to the generated echo image (step S24).

FIG. 14 is a flowchart showing an example of an operation when the target tracking apparatus in the radar equipment according to the embodiment of the present disclosure generates concatenated echo data. Each time the target detector 14 in the target tracking apparatus 101 receives the divided echo data EdD from the radar 20 through the input terminal 11, it executes the process shown in FIG. 14.

Referring to FIG. 12, first, the target detector 14 stores the divided echo data EdD in the memory 13 (step S11).

Next, when the number of divided echo data EdDs accumulated in the memory 13 has not reached N (NO in step S12), the target detector 14 terminates the process.

On the other hand, when the number of divided echo data EdDs stored in the memory 13 has reached N (YES in step S12), the target detector 14 generates the concatenated echo data EdC by connecting the N divided echo data EdDs (step S12).

FIG. 14 is a flowchart showing an example of the operation when the target tracking processor performs tracking processing in the radar equipment 201 according to the embodiment of the present disclosure. The echo data processor 12 in the target tracking apparatus 101 executes the process shown in FIG. 14 each time the concatenated echo data EdC is inputted by the input terminal 11.

Referring to FIG. 14, first, the target detector 14 in the echo data processor 12 performs detection processing to detect the reflector R in the detection target area Ta based on the concatenated echo data EdC inputted by the input terminal 11 (step S21).

Next, the gating processor 16 performs gating processing to set the area Ar. More specifically, the position estimator 15 estimates the current predicted position Pe of the target S based on the past observation position P of the target S and the velocity vector Vc of the target S. Also, the gating processor 16 sets the area Sar based on the size of the target S, the velocity of the target S, and the fluctuation index value IN. Then, the gating processor 16 sets the area Ar centered on the estimated predicted position Pe and having the set area Sar (step S22).

Next, the target selector 17 performs a selection process to select a tracking target Tt from one or more reflectors R in the area Ar. For example, the target selector 17 excludes the reflector R whose fluctuation index value IN is larger than a predetermined value when it is selected as the tracking target Tt from among the reflectors R in the area Ar as the potential tracking target as a tracking target to be selected, as described in the above specific example 1. Then, the target selector 17 selects the reflector R having the smallest distance to the predicted position Pe from the remaining reflectors R in the area Ar as the tracking target Tt (step S23).

Next, the target tracking processor 18 performs a tracking process to track the selected tracking target Tt as the target S. More specifically, the echo data processor 12 generates an echo image including the observation position P of the target S and the velocity vector Vc of the target S and updates the echo image displayed on the display device 30 to the generated echo image (step S24).

When all the reflectors R in the area Ar are excluded from the potential tracking targets and cannot be tracked in step S24, the target tracking processor 18 performs an interpolation process to interpolate the tracking target by the predicted position Pe in the area Ar. Then, in a subsequent step S23, the gating processor 16 sets the area Ar based on the predicted position Pe. That is, the position estimator 15 estimates the current predicted position Pe of the target S based on the predicted position Pe and the velocity vector Vc instead of the observed position P and sets the area Ar centered on the calculated predicted position Pe.

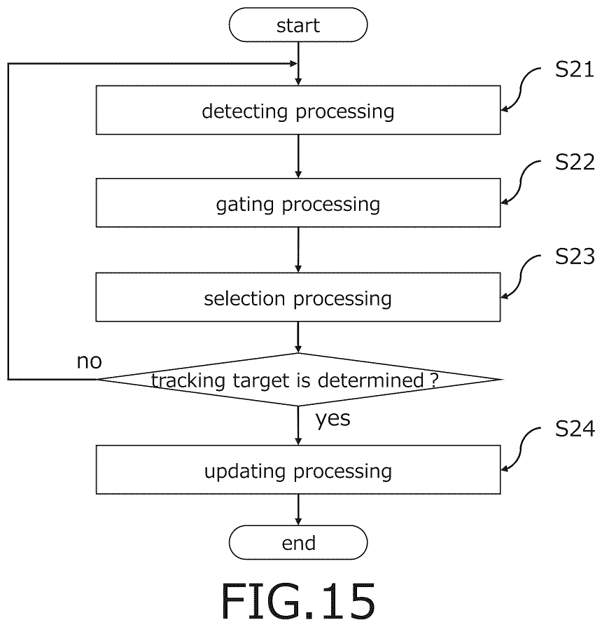

In the flow shown in FIG. 15, after selection processing S23, the target determines whether the next target has been determined. In the case that the next target has been determined, the process proceeds to updating processing S24. On the other hand, in the case that the next target has not been determined or is lost, the tracking is continued by the same process based on the next input echo data.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all of the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application-specific integrated circuit (ASIC), a field programmable gate array (FPGA), or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The above embodiment should be exemplary in all respects and not restrictive. The scope of the present invention is indicated by the claims, not by the above description, and it is intended to include all modifications within the scope and meaning of the claims.

Conditional language such as, among others, “can,” “could,” “might” or “may” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices may also be collectively configured to carry out the stated recitations. For example, “a processor configured to carry out recitations A, B and C” may include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations” without other modifiers, typically means at least two recitations, or two or more recitations).

It will be understood by those within the art that, in general, terms used herein, are generally intended as “open” terms (e.g., the term “including” should be interpreted as “including but not limited to” the term “having” should be interpreted as “having at least” the term “includes” should be interpreted as “includes but is not limited to” etc.).

For expository purposes, the term “horizontal” as used herein is defined as a plane parallel to the plane or surface of the floor of the area in which the system being described is used or the method being described is performed, regardless of its orientation. The term “floor” may be interchanged with the term “ground” or “water surface”. The term “vertical” refers to a direction perpendicular to the horizontal as just defined. Terms such as “above,” “below,” “bottom,” “top,” “side,” “higher,” “lower,” “upper,” “over” and “under” are defined with respect to the horizontal plane.

As used herein, the terms “attached,” “connected,” “mated” and other such relational terms should be construed, unless otherwise noted, to include removable, moveable, fixed, adjustable, and/or releasable connections or attachments. The connections/attachments may include direct connections and/or connections having intermediate structure between the two components discussed. Numbers preceded by a term such as “approximately,” “about” and “substantially” as used herein include the recited numbers, and also represent an amount close to the stated amount that still performs a desired function or achieves a desired result. For example, the terms “approximately,” “about” and “substantially” may refer to an amount that is less than 10% of the stated amount. Features of embodiments disclosed herein preceded by a term such as “approximately,” “about” and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

Representative embodiments of the present invention will be listed below.
(1) A target tracking apparatus for tracking a target, comprising: an input terminal configured to acquire echo data indicating the relationship between a level of signal reflected by a reflector in a detection area and its position; a processing circuitry configured to: detect one or a plurality of potential tracking targets having the level of the echo data equal to or higher than a predetermined value; estimate each predicted position of the potential tracking target; set an area where the potential tracking targets to be tracked may exist, which comprises the predicted position and is narrower than the detection area; select a tracking target from one or a plurality of the potential tracking targets in the area; track the selected tracking target as a tracking target.
(2) The target tracking apparatus according to (1), wherein: the input terminal is configured to repeatedly acquire the echo data; and the processing circuitry is configured to: detect the potential tracking targets; estimate each predicted position of the potential tracking target based on tracking target information including previously detected target positions; set a new area each time the potential tracking targets are detected; select the tracking target from the potential tracking targets in the new area; track the selected tracking target as a tracking target.
(3) The target tracking apparatus according to (2), wherein: the processing circuitry is further configured to: calculate an index value indicating fluctuation of the target; and set the area based on the index value.
(4) The target tracking apparatus according to (3), wherein: the processing circuitry is further configured to: select the tracking target having the minimum index value in the area.
(5) The target tracking apparatus according to (1), wherein: the processing circuitry is further configured to: calculate an index value based on change in the velocity vector of the target; and set the area based on the index value.
(6) The target tracking apparatus according to (1), wherein: the processing circuitry is further configured to: calculate an index value based on change in the velocity of the target; and set the area based on the index value.
(7) The target tracking apparatus according to (1), wherein: the processing circuitry is further configured to: calculate an index value based on change in the position of the target; and set the area based on the index value.
(8) The target tracking apparatus according to (1), wherein: the processing circuitry is further configured to: calculate an index value based on the velocity of the target; and set the area based on the index value.
(9) The target tracking apparatus according to (1), wherein: the processing circuitry is further configured to: calculate an index value based on the size of the target; and set the area based on the index value.
(10) The target tracking apparatus according to any of (2) to (9), wherein: the processing circuitry is configured to: discard the potential tracking targets, in the case that the tracking target is missing; and set the area based on the predicted positions of the detected potential tracking targets at a latest timing.
(11) The target tracking apparatus according to any of (2) to (9), wherein: the processing circuitry is configured to set the area based on the predicted position at a latest timing, in the case that the tracking target is not determined; discard the potential tracking targets, in the case that the tracking target is not determined; and set the area based on the predicted positions of the detected potential tracking targets at a latest timing.
(12) The target tracking apparatus according to any of (2) to (9), wherein: the processing circuitry is further configured to: calculate an index value indicating fluctuation of the target; and select the tracking target on the index value.
(13) The target tracking apparatus according to (2), further comprising: an antenna configured to emit an electromagnetic wave; a transmitter/receiver configured to: transmit the electromagnetic wave through the antenna; receive a reflected signal from which the transmitted electromagnetic wave is reflected by a reflector; generate the echo database on the reflected signal; and output the echo data into the input terminal, and a display configured to display the tracked target.
(14) A target tracking method for tracking a target in detecting area, comprising: receiving a reflected signal wave reflected in the detecting area by electromagnetic waves transmitted through an antenna; outputting echo data indicating the correspondence between the position in the detecting area and the level of reflected waves; detecting one or a plurality of potential tracking targets having a level of the reflected wave equal to or higher than a predetermined value based on the echo data; estimating the predicted position of the potential tracking targets in the future; setting an area where the potential tracking targets to be tracked may exist, including the predicted position; selecting a tracking target from one or a plurality of the potential tracking targets in the area; tracking the selected tracking target as a tracking target.
(15) The target tracking method according to (14), wherein: receiving the reflected signal each time the electromagnetic wave is transmitted, repeatedly, detecting the potential targets each time, estimating each predicted position of the potential tracking target, setting a new area each time the potential tracking targets are detected, selecting the tracking target from the potential tracking targets in the new area, and tracking the selected tracking target as a tracking target repeatedly.
(16) The target tracking method according to (15), further comprising: calculating an index value indicating fluctuation of the target; and setting the area based on the index value.
(17) The target tracking method according to (16), comprising: selecting the tracking target having the minimum index value in the area.
(18) The target tracking method according to (14), further comprising: calculating an index value based on change in the velocity vector of the target; and setting the area based on the index value.
(19) The target tracking method according to any of (14) to (18), further comprising: discarding the potential tracking targets, in the case that the tracking target is missing; and setting the area based on the predicted positions of the detected potential tracking targets at a latest timing.
(20) A non-transitory computer-readable medium having stored thereon computer-executable instructions which, when executed by a computer, cause the computer to:
   receive a reflected signal wave reflected in the detecting area by electromagnetic waves transmitted through an antenna;
   output echo data indicating the correspondence between the position in the detecting area and the level of reflected waves;
   detect one or a plurality of potential tracking targets having a level of the reflected wave equal to or higher than a predetermined value based on the echo data;
   estimate the predicted position of the potential tracking targets in the future;
   set an area where the potential tracking targets to be tracked may exist, including the predicted position;
   select a tracking target from one or a plurality of the potential tracking targets in the area;
   track the selected tracking target as a tracking target.

### DESCRIPTION OF REFERENCE CHARACTERS

1 ship
11 input terminal
12 echo data processor
13 memory
14 target detector
15 position estimator
16 gating processor
17 target selector
18 target tracking processor
20 radar
21 antenna
22 transmitter/receiver
30 display
101 target tracking component
Ta detection target area
P observation position
Vc, Vr2, Vr3 velocity vector
R, R1, R2, R3, R4 reflectors
Pe predicted position
Ar, Ar1, Ar2 areas
VaX, VaY absolute values for indicating fluctuation values

1. A target tracking apparatus for tracking a target, comprising:
an input terminal configured to acquire echo data indicating the relationship between a level of signal reflected by a reflector in a detection area and its position;
processing circuitry configured to:
detect one or a plurality of potential tracking targets having the level of the echo data equal to or higher than a predetermined value;
estimate each predicted position of the potential tracking target;
set an area where the potential tracking targets to be tracked may exist, which comprises the predicted position and is narrower than the detection area;
select a tracking target from one or a plurality of the potential tracking targets in the area;
track the selected tracking target as a tracking target.

2. The target tracking apparatus according to claim 1, wherein:
the input terminal is configured to repeatedly acquire the echo data; and
the processing circuitry is configured to:
detect the potential tracking targets;
estimate each predicted position of the potential tracking target based on tracking target information including previously detected target positions;
set a new area each time the potential tracking targets are detected;
select the tracking target from the potential tracking targets in the new area;
track the selected tracking target as a tracking target.

3. The target tracking apparatus according to claim 2, wherein:
the processing circuitry is further configured to:
calculate an index value indicating fluctuation of the target; and
set the area based on the index value.

4. The target tracking apparatus according to claim 3, wherein:
the processing circuitry is further configured to:
select the tracking target having the minimum index value in the area.

5. The target tracking apparatus according to claim 1, wherein:
the processing circuitry is further configured to:
calculate an index value based on change in the velocity vector of the target; and
set the area based on the index value.

6. The target tracking apparatus according to claim 1, wherein:
the processing circuitry is further configured to:
calculate an index value based on change in the velocity of the target; and
set the area based on the index value.

7. The target tracking apparatus according to claim 1, wherein:
the processing circuitry is further configured to:
calculate an index value based on change in the position of the target; and
set the area based on the index value.

8. The target tracking apparatus according to claim 1, wherein:
the processing circuitry is further configured to:
calculate an index value based on the velocity of the target; and
set the area based on the index value.

9. The target tracking apparatus according to claim 1, wherein:
the processing circuitry is further configured to:
calculate an index value based on the size of the target; and
set the area based on the index value.

10. The target tracking apparatus according to claim 2, wherein:
the processing circuitry is configured to:
discard the potential tracking targets, in the case that the tracking target is missing; and
set the area based on the predicted positions of the detected potential tracking targets at a latest timing.

11. The target tracking apparatus according to claim 2, wherein:
the processing circuitry is configured to set the area based on the predicted position at a latest timing, in the case that the tracking target is not determined;
discard the potential tracking targets, in the case that the tracking target is not determined; and
set the area based on the predicted positions of the detected potential tracking targets at a latest timing.

12. The target tracking apparatus according to claim 2, wherein:
the processing circuitry is further configured to:
calculate an index value indicating fluctuation of the target; and
select the tracking target on the index value.

13. The target tracking apparatus according to claim 2, further comprising:
an antenna configured to emit an electromagnetic wave;
a transmitter/receiver configured to:
transmit the electromagnetic wave through the antenna;
receive a reflected signal from which the transmitted electromagnetic wave is reflected by a reflector;
generate the echo database on the reflected signal; and
output the echo data into the input terminal, and
a display configured to display the tracked target.

14. A target tracking method for tracking a target in a detection area, comprising:
receiving a reflected signal wave reflected in the detecting area by electromagnetic waves transmitted through an antenna;
outputting echo data indicating the correspondence between the position in the detecting area and the level of reflected waves;
detecting one or a plurality of potential tracking targets having a level of the reflected wave equal to or higher than a predetermined value based on the echo data;
estimating the predicted position of the potential tracking targets in the future;
setting an area where the potential tracking targets to be tracked may exist, including the predicted position;
selecting a tracking target from one or a plurality of the potential tracking targets in the area;
tracking the selected tracking target as a tracking target.

15. The target tracking method according to claim 14, wherein:
receiving the reflected signal each time the electromagnetic wave is transmitted, repeatedly, detecting the potential targets each time,
estimating each predicted position of the potential tracking target, setting a new area each time the potential tracking targets are detected, selecting the tracking target from the potential tracking targets in the new area, and
tracking the selected tracking target as a tracking target repeatedly.

16. The target tracking method according to claim 15, further comprising:
calculating an index value indicating fluctuation of the target; and
setting the area based on the index value.

17. The target tracking method according to claim 16, comprising:
selecting the tracking target having the minimum index value in the area.

18. The target tracking method according to claim 14, further comprising:
calculating an index value based on change in the velocity vector of the target; and
setting the area based on the index value.

19. The target tracking method according to claim 14, further comprising:
discarding the potential tracking targets, in the case that the tracking target is missing; and
setting the area based on the predicted positions of the detected potential tracking targets at a latest timing.

20. A non-transitory computer-readable medium having stored thereon computer-executable instructions which, when executed by a computer, cause the computer to:
receive a reflected signal wave reflected in the detecting area by electromagnetic waves transmitted through an antenna;
output echo data indicating the correspondence between the position in the detecting area and the level of reflected waves;
detect one or a plurality of potential tracking targets having a level of the reflected wave equal to or higher than a predetermined value based on the echo data;
estimate the predicted position of the potential tracking targets in the future;
set an area where the potential tracking targets to be tracked may exist, including the predicted position;
select a tracking target from one or a plurality of the potential tracking targets in the area;
track the selected tracking target as a tracking target.
